(19) United States
(12) Patent Application Publication
(10) Pub. No.: US 2016/0232692 A1
(43) Pub. Date: Aug. 11, 2016

(54) DISPLAYING MULTIVARIATE DATA IN MULTIPLE DIMENSIONS

(71) Applicant: HEWLETT PACKARD ENTERPRISE DEVELOPMENT LP, Houston, TX (US)

(72) Inventor: Ian N. Robinson, Pebble Beach, CA (US)

(21) Appl. No.: 15/023,341

(22) PCT Filed: Oct. 9, 2013
(86) PCT No.: PCT/US2013/063978

§ 371 Date: Mar. 18, 2016

(51) Int. Cl. G06T 11/20; G06F 17/30

(52) U.S. Cl. CPC G06T 11/206; G06F 17/30572

(57) ABSTRACT

Displaying multivariate data in multiple dimensions can include identifying a common data element and displaying a multivariate multidimensional (MVMD) graph including a polyline representing the common data element.

### BACKGROUND

Data, such as values of qualitative and/or quantitative variables, belonging to a set of items, can be visually represented in a structure, often tabular, a tree, and/or a graph structure. Information and/or knowledge can be derived from visual representations of data. For instance, users can identify efficiencies, inefficiencies, areas for improvement, patterns, and outliers to direct actions. Analysis and visual representation of data can be simple or complex, and in many examples can include a collection of datasets so large and complex that it is difficult to process such data using traditional data processing applications.

### BRIEF DESCRIPTION OF THE DRAWINGS

FIGS. 1A-1B illustrate an example construction of a multivariate and multidimensional (MVMD) graph according to the present disclosure.

FIGS. 2A-2B illustrate examples of systems according to the present disclosure.

FIGS. 3A-3C illustrate examples of modifications of a visualization effect of an MVMD graph according to the present disclosure.

FIGS. 4A-4B illustrate examples of modifications of an MVMD graph according to the present disclosure.

FIG. 5 illustrates a flow chart of an example method for displaying multivariate data in multiple dimensions according to the present disclosure.

### DETAILED DESCRIPTION

Several data analytics tools exist that enable users to inspect, clean, transform, and model data with the goal of discovering useful information. Data analysis encompasses diverse techniques, and each technique provides different advantages to a user. Furthermore, the utility of data analytics techniques has increased, and more advanced data mining, data analytics, and data modeling tools have been developed that are capable of compiling and analyzing large amounts of data, and more particularly, multivariate data (e.g., data having a large number of distinct, although not necessarily independent, variables). However, with an increase in the complexity and diversity in data analytics and modeling tools, it has become increasingly difficult to extract meaning from data which is presented in different formats. For instance, it may be desirable to find and analyze correlations between two or more different graphs of the same data, each graph plotting different variables associated with the data. Finding and visualizing correlations between the two can be difficult and time intensive.

Some systems enable two-dimensional (2D) visualization of complex datasets. In one such system, termed “parallel coordinates”, one dimension is used to show common data points between a plurality of datasets. That is, a plurality of datasets can be combined to generate a composite graph illustrating the common points between the datasets. Such systems attempt to exploit spatial properties to display multivariate data, but the representations of the datasets themselves are abstracted down to a single linear axis and a number of familiar and effective visualization techniques cannot be used (maps, for example). A development of this technique, three-dimensional (3D) parallel coordinates, extends this technique to 2D scatterplots arranged parallel to each other in a third dimension (e.g., the 3D visualization of gene inter-relationships in Drosophila melanogaster cells). However, this system only compares the distribution points in scatterplot graphs to identify characteristic relationships between particular genes, and does not encompass other types of 2D visualization.

In contrast, in accordance with examples of the present disclosure, multivariate data can be presented in a multidimensional graph. The presentation of data in a multivariate and multidimensional (MVMD) graph can simultaneously present a number of 2D visualizations (e.g., on layers and/or planes), which describe different aspects and/or facets of the data, and/or illustrate interconnections between the number of 2D visualizations in the third dimension to further illustrate how the data is connected between all of the views. Furthermore, the presentation of data in an MVMD graph enables a user to interact with the data to further manipulate and explore the data. As used herein, an MVMD graph includes a visual representation of a plurality of planes, wherein each plane includes a 2D graph, displayed with a depth perspective illustrating multiple dimensions, and connected in a manner to illustrate correlations. An MVMD graph can be presented as an orthographic or perspective projection (e.g., a representation of a three-dimensional object in 2D), as well as a three-dimensional projection (e.g., on a stereographic 3D display) of a three-dimensional object. As used herein, a perspective projection refers to a method for creating a 2D rendering of a 3D object based on projecting points in the object through a common viewpoint onto an image plane.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an element and/or feature can refer to one or more of such elements and/or features. For example, “a number of planes” can include one or more planes. Also, as used herein, the phrase “substantially similar” refers to a plurality of items having a quality and/or quantity within a specified threshold.

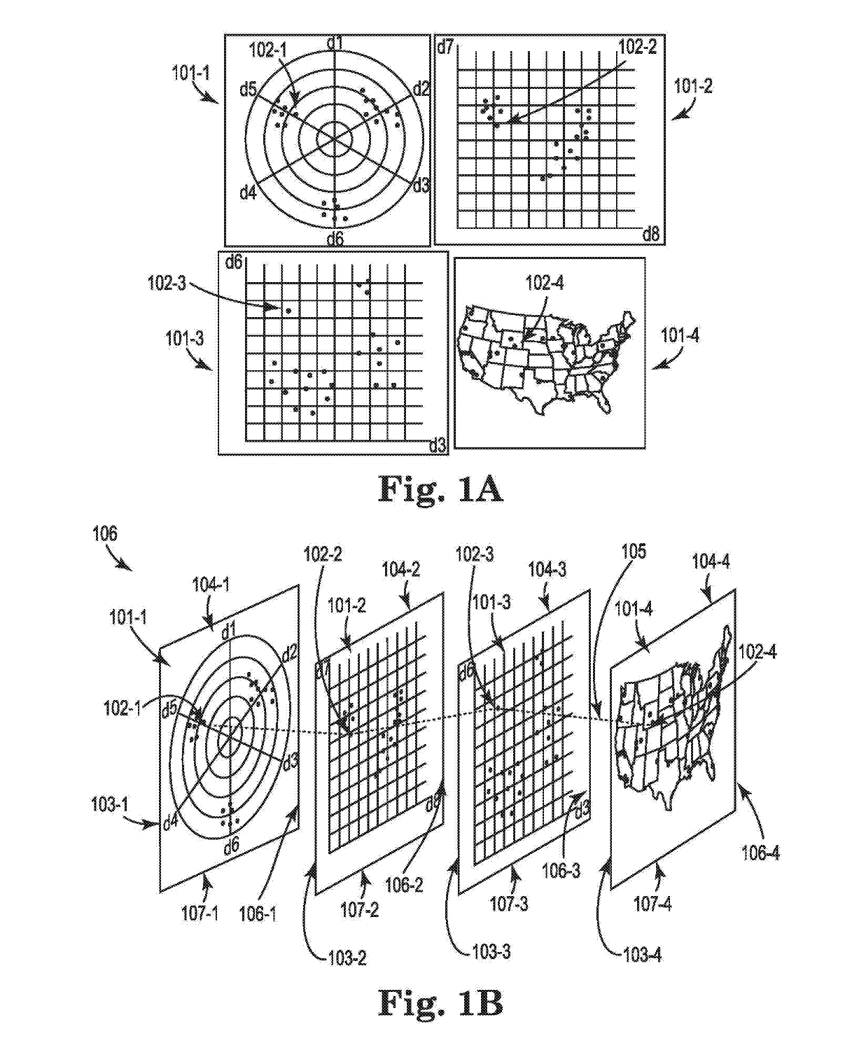

FIGS. 1A and 1B illustrate an example construction of a multivariate and multidimensional (MVMD) graph. As used herein, an MVMD graph can include a number of individual graphical visualizations, combined into a multidimensional visualization, and connected to illustrate common data elements. As used herein, multivariate data includes data having a number of distinct, although not necessarily independent, variables. Common data elements can include a number of values, parameters, metadata, and/or qualities that are associated with data. In some examples, data elements can be considered common if they are associated with the same transaction. For instance, a particular financial transaction can include a number of data elements describing the transaction, such as the sale price, the date and/or time of the transaction, the profit margin realized from the transaction and/or the geographic location of the transaction, among other values, parameters, metadata, and/or qualities. Each of the data elements associated with the transaction can be considered a common data element, and can be connected on an MVMD graph. Furthermore, each of the individual graphical visualizations included in an MVMD graph can include multivariate data.

FIG. 1A illustrates a plurality of individual graphical visualizations (e.g., 2D graphs) which can be combined to create an MVMD graph 106 shown in FIG. 1B. Each of the plurality of 2D graphs can be displayed on a separate plane (e.g., first plane 101-1, second plane 101-2, third plane 101-3, and fourth plane 101-4), wherein each plane as two vertical edges and two horizontal edges. In a number of examples, each of the 2D graphs can be of a different type, and/or a number of the 2D graphs can be of the same type. For instance, the first plane 101-1 can contain a RadViz plot (e.g., a radial, force-driven point layout), whereas the second plane 101-2 and the third plane 101-3 can contain scatterplots, and the fourth plane 101-4 can contain a geographical data visualization. Examples in accordance with the present disclosure are not so limited, however, and each of the 2D graphs can be of any type of graphical visualization that represents data elements as discrete paints.

In a number of examples, a plurality of planes containing 2D graphs (e.g., first plane 101-1, . . . , fourth plane 101-4, herein referred to as “the plurality of planes 101”) can be selected for constructing an MVMD graph 106. For instance, the plurality of planes 101 can be selected from a database of existing planes containing 2D graphs. In some examples, prior to constructing the MVMD graph 106, multivariate data can be analyzed and a plurality planes 101 can be constructed to represent the analyzed multivariate data, wherein each of the plurality of planes 101 includes a graphical surface having a first vertical edge (e.g., vertical edge 103-1, vertical edge 103-2, vertical edge 103-2, vertical edge 103-4) and a second vertical edge (e.g., vertical edge 106-1, vertical edge 106-2, vertical edge 106-3, vertical edge 106-4), and a first horizontal edge (e.g., horizontal edge 104-1, horizontal edge 104-2, horizontal edge 104-3, horizontal edge 104-4) and a second horizontal edge (e.g., horizontal edge 107-1, horizontal edge 107-1 horizontal edge 107-3, horizontal edge 107-4). For instance, analytics can be run on raw multivariate data to identify clusters, outliers, correlations, and/or trends, which can be presented in a 2D graph (e.g., on first plane 101-1) as a RadViz plot having two vertical edges (e.g., first vertical edge 103-1 and second vertical edge 106-1) and two horizontal edges (e.g., horizontal edge 104-1 and horizontal edge 107-1). In another example, the results of analytics can be presented in a scatterplot, for example, and presented in a 2D graph on the second plane 101-2, which similarly has two vertical edges (e.g., vertical edge 103-2 and vertical edge 106-2) and two horizontal edges (e.g., horizontal edge 104-2 and horizontal edge 107-2). As used herein, a “vertical edge” and a “horizontal edge” of a plane refers to an edge, margin, border, rim and/or side of a plane extending in a vertical and horizontal direction, respectively.

FIG. 1B illustrates an example of a constructed MVMD graph 106 according to the present disclosure. A plurality of planes 101 can be combined to form an MVMD graph 106. For example, a user can select a first plane 101-1 of a first graph type (e.g., a RadViz Plot) and a second plane 101-2 of a second graph type (e.g., scatterplot), wherein the 2D graph on the first plane 101-1 includes a first set of data points and the 2D graph on the second plane 101-2 includes a second set of data points. However, examples are not so limited, and the plurality of planes 101 car be selected for constructing the MVMD graph 106 by a non-transitory computer-readable medium storing a set of instructions executable by the processing resource, as discussed further herein.

As illustrated in FIG. 1B, a constructed MVMD graph 106 can include a plurality of planes 101 displayed in a multidimensional (e.g., 3D) visualization. For instance, the first plane 101-1 containing a first 2D graph, can have a first vertical edge 103-1, second vertical edge 106-1, a first horizontal edge 104-1 and a second horizontal edge 107-1, and a second plane 101-2 containing a second 2D graph, can have a first vertical edge 103-2, a second vertical edge 106-2, a first horizontal edge 104-2 and a second horizontal edge 107-2. Similarly, as illustrated in FIG. 1B, third plane 101-3 and fourth plane 101-4 can contain a third 2D graph and a fourth 2D graph, respectively, and each have two vertical edges and two horizontal edges.

The plurality of planes 101 can be displayed in a parallel orientation such that the first vertical edge of the second plane overlays the first vertical edge of the first plane, and the overlaid 2D graphs can be rotated about a vertical axis of the MVMD graph such that the first vertical edge of the second plane and the first vertical edge of the first plane are closer to a viewer than the second vertical edge of the second plane and the second vertical edge of the first plane. The plurality of planes 101 can be spaced apart such that one plane (e.g., the second plane 101-2) does not occlude part of another plane (e.g., the first plane 101-1), and the rotation can be such that the first vertical edge of each plane can be located to the left of the second vertical edge of each plane. For example, the second plane 101-2 can overlay (e.g., transposed on top of) the first plane 101-1, such that the vertical edges (e.g., first vertical edge 103-2 and second vertical edge 106-2) of the second plane 101-2 are parallel to the vertical edges (e.g., first vertical edge 103-1 and second vertical edge 106-1) of the first plane 101-1, and the horizontal edges (e.g., first horizontal edge 104-2 and second horizontal edge 107-2) of the second plane 101-2 are parallel to the horizontal edges (e.g., first horizontal edge 104-1 and second horizontal edge 107-1) of the first plane 101-1. The overlaid planes (e.g., second plane 101-2 and first plane 101-1) can be rotated about a vertical axis (not shown in FIG. 1B) such that the plurality of planes 101 appear to be stacked in the third dimension. As illustrated in FIG. 1B, first vertical edges 103-1, 103-2, 103-3, and 103-4 appear closer to a viewer than second vertical edges 106-1, 106-2, 106-3, and 106-4, while all vertical edges remain parallel to one another.

In a number of examples, a common data element can be identified among a plurality of planes 101 comprising the MVMD graph 106. As previously discussed, a common data element can include a number of values, parameters, metadata, and/or qualities that are associated with the data. For instance, a data point from a first set of data (e.g., first data point 102-1) on the first plane 101-1 and a data point from a second set of data (e.g., second data point 102-2) on the second plane 101-2 can be identified as being related to a common data element. Similarly, a data point from a third set of data (e.g., third data point 102-3) on third plane 101-3 and a data point from a fourth set of data (e.g., fourth data point 102-4) on fourth plane 101-4 can be identified as sharing the common data element identified between the first data point 102-1 and the second data point 102-2. While FIG. 1B illustrates four planes included in the MVMD graph 106 and displayed in a multidimensional graph, examples are not so limited, and the MVMD graph 106 can include more or less planes than illustrated.

A common data element identified between a first plane 101-1 and a second plane 101-2 can be connected to visually depict a correlation between the two planes 101-1, 101-2. For example, first data point 102-1 on the first plane 101-1 can be connected to second data point 102-1 on the second plane 101-2 by a polyline (e.g., polyline 105) representing the common data element between the two data points. As used herein, a polyline refers to a line composed of one or more line segments. Similarly, a data point on the third plane 101-3 (e.g., third data point 102-3) and a data point on the fourth plane 101-4 (e.g., fourth data point 102-4) can be connected by polyline 105, representing a common data element between the data points 102-1, 102-2, 102-3, and 102-4. Examples are not so limited, however, and a polyline can include curved lines, among other line types.

In some examples, the MVMD graph 106 can include a plurality of polylines representing a plurality of common data elements between various data points on the plurality of planes 101. Similarly, a data point on a particular plane can be connected to a plurality of polylines. For instance, first data point 102-1 can be connected to polyline 105, representing a first common data element, and can be connected to a second polyline (not illustrated in FIG. 1B) representing a second common data element. Additionally, polyline 105 can represent a common data element among a portion of the MVMD graph (e.g., connecting less than all of the plurality of planes 101). For instance, polyline 105 can connect second data point 102-2 and third data point 102-3, but not first data point 101-1 and fourth data point 102-4. As discussed further herein, the MVMD graph 106 can be manipulated in a number of ways to illustrate and/or emphasize portions of the MVMD graph 106.

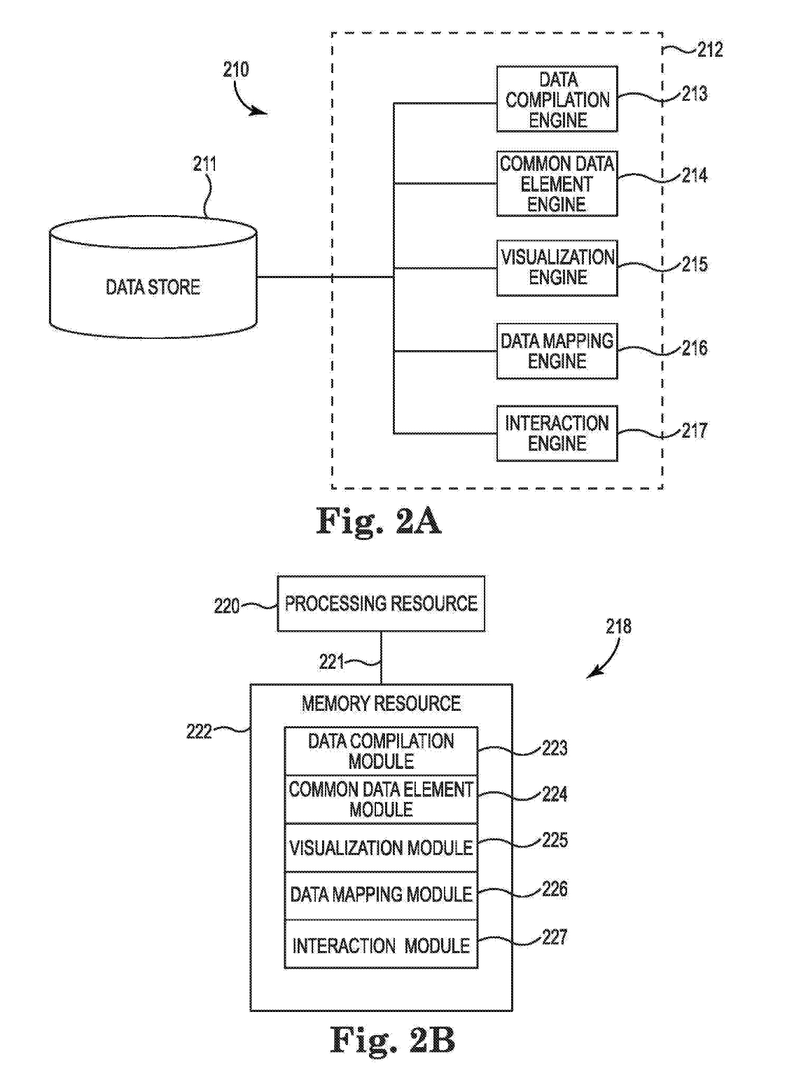

FIGS. 2A-2B illustrate examples of systems 210, 218 according to the present disclosure. FIG. 2A illustrates a diagram of an example of a system 210 for displaying and interacting with multivariate data in multiple dimensions according to the present disclosure. The system 210 can include a data store 211, a subsystem 212, and/or a number of engines 213, 214, 215, 216, 217. The subsystem 212 can include the number of engines (e.g., data compilation engine 213, common data element engine 214, visualization engine 215, data mapping engine 216, and/or interaction engine 217) and can be in communication with the data store 211 via a communication link. The system 210 can include additional or fewer engines than illustrated to perform the various functions described herein.

The number of engines can include a combination of hardware and programming that is configured to perform a number of functions described herein (e.g., identify a common data element among a plurality of planes selected for an MVMD graph). The programming can include program instructions (e.g., software, firmware, etc,) stored in a memory resource (e..g., computer readable medium, machine readable medium, etc.) as well as hard-wired program (e.g., logic).

The data compilation engine 213 can include hardware and/or a combination of hardware and programming to compile raw data to create a plurality of planes, wherein each of the plurality of planes contains a 2D graph and includes a graphical surface having a first and a second vertical edge, and a first and a second horizontal edge. For example, in accordance with some examples of the present disclosure, analytics can be run on raw data to identify clusters, outliers, correlations, and/or trends, among other qualitative data analysis determinations. The results of analytics can be presented on a plurality of graphs on a plurality of planes. Additionally, raw data can be presented in a plurality of planes, wherein each of the plurality of planes contains a graph including a different set of related data and/or a different set of variables.

The common data element engine 214 can include hardware and/or a combination of hardware and programming to identify a common data element among a plurality of planes selected for an MVMD graph. A common data element can be identified among a plurality of planes using a number of means. For example, the common data element engine 214 can identify that a data point in a first plane is associated a particular business unit within an organization, based on metadata associated with the graph contained in the first plane. Similarly, the common data element engine 214 can identify that a data point in a second plane is associated with the same business unit, based on metadata associated with the graph contained in the second plane. Examples are not so limited, however, and the common data element, engine 214 can identify a common data element among a plurality of planes using including data mining took, statistical analysis tools, and/or raw data comparison tools, among others.

The visualization engine 215 can include hardware and/or a combination of hardware and programming to display the MVMD graph, including the plurality of planes, in an orientation wherein the plurality of planes are parallel to one another and rotated about a vertical axis such that the first vertical edge of each of the plurality of planes is closer to a viewer than the second vertical edge of each of the plurality of planes. A plurality of planes, selected for inclusion in the MVMD graph and/or constructed for inclusion in the MVMD graph, can be displayed in a parallel orientation, as discussed in relation to FIG. 1B. As discussed further in relation to FIGS. 1A and 1B, each plane can include two vertical edges (e.g., vertical edges) as well as two horizontal edges (e.g., horizontal edges).

The data mapping engine 216 can include hardware and/or a combination of hardware and programming to display a polyline on the MVMD graph, wherein the polyline connects data points on each of the plurality of planes and represents the common data element among the plurality of planes. In a number of examples, a polyline that passes through parts of select planes can be turned off, far instance, to allow a user to more effectively analyze a portion of the MVMD graph. In some examples, the data mapping engine 216 can display a plurality of polylines on the MVMD graph and the interaction engine 217 can enhance a particular polyline selected from the plurality of polylines (e.g., as discussed further herein).

The interaction engine 217 can include hardware and/or a combination of hardware and programming to display a modification of the MVMD graph in response to a user input. A modification can include any change in the visual presentation of the MVMD graph in response to a user input. For example, a user can provide input requesting various cluster selection techniques be implemented to explore a particular data set cluster selection techniques can include lassoing, or otherwise selecting, a region in a graph on a plane, or selecting regions in a particular graph on a plane for analysis.

Polylines passing through a selected region can be highlighted to enable visual exploration of data elements common to a selected region. In some examples, a user can select a single polyline and can alter the visual effects of the selected polyline. Additionally, some planes can contain 2D graphs that employ colored regions to visually distinguish different characteristics of the graph contained therein. In some examples, a user can provide input selecting such a plane in the MVMD graph, and can cause all the polylines passing through the selected plane to be colored according to the area of the graph that they pass through. In some examples, a plurality of colors can be assigned to different polylines within the MVMD graph to visually distinguish different characteristics.

In a number of examples, the interaction engine 217 can collapse selected planes from the MVMD graph about a vertical axis such that the graphical surface of the selected planes are not visible to the user, in response to user input. For example, in response to user input, interaction engine 217 can collapse a selected plane about a vertical axis of the plane such that only the vertical edge of the plane is visible. This allows more screen space to be devoted to the remaining planes. As discussed further herein, collapsing a plane does not change the number of polylines connecting it to its neighboring planes.

The interaction engine 217 in various examples can modify a visualization effect of a plane in the MVMD graph, in response to user input. For example, modifying the visualization effect can include changing spatial orientation of the plane such that the graphical surface of the plane does not visually obstruct the graphical surface of a second plane in the MVMD graph. In a number of examples, modifying the visualization effect can include modifying the opacity of a selected plane. In some examples, modifying the visualization effect can include changing the degree of rotation of the plurality of planes about the vertical axis.

In some examples, the number of data points in an MVMD graph can become large enough that visually marking each data point and polyline becomes impractical. In such examples, the plurality of planes can be changed to indicate (e.g., by means of color) the density of data points in a region of a 2D graph. For instance, a high density area of data points in a region of a 2D graph can be indicated with a red color and a low density area of data points in a region of a 2D graph can be indicated with a green color. The polylines associated with high or low density areas of a selected 2D graph can be similarly colored. In some examples, the polylines connecting data points can be rendered with an opacity that depends on the local density of polylines in that region of the MVMD graph.

FIG. 2B illustrates a diagram of an example computing device 218 according to the present disclosure. The computing device 218 can utilize software, hardware, firmware, and/or logic to perform a number of functions described herein.

The computing device 218 can be any combination of hardware and program instructions configured to share information. The hardware, for example can include a processing resource 220 and/or a memory resource 222 (e.g., computer-readable medium (CRM) machine readable medium (MRM), database, etc.) A processing resource 220, as used herein, can include any number of processors capable of executing instructions stored by a memory resource 222. Processing resource 220 may be integrated in a single device or distributed across multiple devices. The program instructions (e.g., computer-readable instructions (CRI)) can include instructions stored on the memory resource 222 and executable by the processing resource 220 to implement a desired function (e.g., modify a visualization effect of a plane in the MVMD graph, in response to user input).

The memory resource 222 can be in communication with a processing resource 220. A memory resource 222, as used herein, can include any number of memory components capable of storing instructions that can be executed by processing resource 220. Such memory resource 222 can be a non-transitory CRM or MRM. Memory resource 222 may be integrated in a single device or distributed across multiple devices. Further, memory resource 222 may be fully or partially integrated in the same device as processing resource 220 or it may be separate but accessible to that device and processing resource 220. Thus, it is noted that the computing device 218 may be implemented on a participant device, on a server device, on a collection of server devices, and/or a combination of the user device and the server device.

The memory resource 222 can be in communication with the processing resource 220 via a communication link (e.g., a path) 221. The communication link 221 can be local or remote to a machine (e.g., a computing device) associated with the processing resource 220. Examples of a local communication link 221 can include an electronic bus internal to a machine (e.g., a computing device) where the memory resource 222 is one of volatile, non-volatile, fixed, and/or removable storage medium in communication with the processing resource 220 via the electronic bus.

A number of modules 223, 224, 225, 226, 227 can include CRI that when executed by the processing resource 220 can perform a number of functions. The number of modules 223, 224, 225, 226, 227 can be sub-modules of other modules. For example, the data compilation module 223 and the common data element module 224 can be sub-modules and/or contained within the same computing device. In another example, the number of modules 223, 224, 225, 226, 227 can comprise individual modules at separate and distinct locations (e.g., CRM, etc.).

Each of the number of modules 223, 224, 225, 226, 227 can include instructions that when executed by the processing resource 220 can function as a corresponding engine as described herein. For example, the data compilation module 223 can include instructions that when executed by the processing resource 220 can function as the data compilation engine 213. In another example, the common data element module 224 can include instructions that when executed by the processing resource 220 can function as the common data element engine 214.

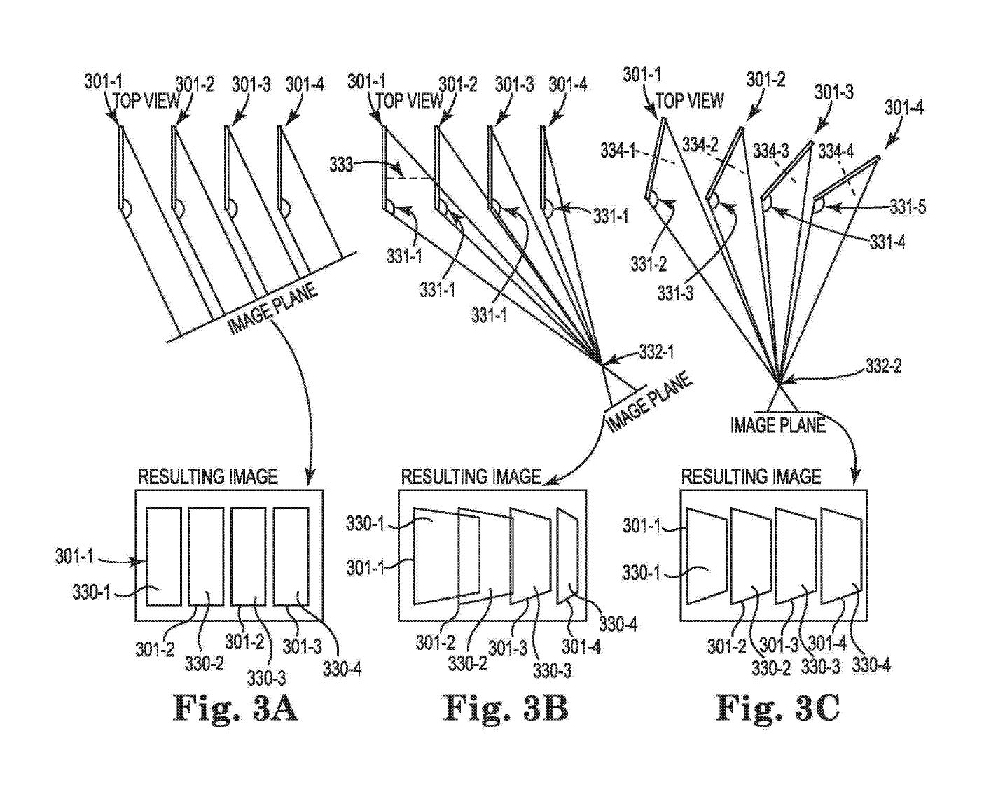

FIGS. 3A-3C illustrate alternative methods for visually representing an MVMD graph according to the present disclosure. For example, as illustrated in the top views of FIGS. 3A and 3B, a plurality of planes 301 can be oriented in a parallel overlay to create a multidimensional graph. Each of the planes can include a graphical surface that displays the graphical data (e.g., graphical surface 330-1, 330-2, 330-3, 330-4). The planes (as illustrated in FIG. 3A) can be visually represented as an orthographic projection (e.g., a representation of a three-dimensional object in two dimensions that does not use perspective projection). This results in the individual planes being displayed with substantially similar size, aspect ratio (e.g., proportional relationship between width and height) and/or spacing. However, such visual presentation can diminish depth cues due to the lack of perspective for each of the planes. As used herein depth cue refers to perceptual cues in an image (e.g., relative sizes due to perspective effects, occlusion, shadows, and/or stereo disparity) that provide an indication of an object's distance from the viewer. The depth perception of the graph on first plane 301-1 may be diminished due to the lack of perspective of foreshortening the first plane 301-1. The resulting image, as shown in FIG. 3A, can include a plurality of planes 301 lacking in depth perspective. A usable stereographic rendering would not be possible using orthographic projection.

As illustrated in FIG. 3B, when the MVMD graph is rendered using a perspective projection, then depth cues due to perspective effects are present, but the various planes have inconsistent areas and spacing. The inconsistent spacing can result in the planes overlapping as shown in FIG. 3B, which diminishes the clarity of the displayed area. FIG. 3C illustrates an arrangement where the planes are arranged so as to appear turned at the same angle 331-1 to the viewpoint 332-1 and with equal separation (e.g., distance 333). As with the scheme illustrated in FIG. 3B, the use of a perspective projection preserves perspective depth cues in 2D, and allows for the generation of usable stereographic 3D images. In this case however, the graph sizes, aspect ratios and spacing are roughly equal and overlaps can be avoided.

In the arrangements of FIGS. 3A and 3B, a user can navigate around the MVMD graph by moving their viewpoint. For example, moving viewpoint 332-1 to the right (e.g., panning to the right) can expose more of the graphical surface of each of the plurality of planes 301. Additionally, rotating the MVMD graph about a central axis (not illustrated in FIGS. 3A-3C) can allow polylines on the MVMD graph to be explored from different angles. In FIG. 3C, a visual effect similar to panning can be achieved by rotating each of the planes about its first vertical edge by an equal angle (e.g., angles 331-2, 331-3, 331-4, 331-5). Additionally, instead of rotating the viewpoint 332-2 around the plurality of planes 301, each of the plurality of planes 301 can be rotated about the central axis (e.g., 334-1, 334-2, 334-3, 334-4) of each plane. The resulting image in FIG. 3C can include each of the plurality of planes 301 rendered without overlapping, and each of the plurality of planes 301 presented with depth perspective. User-configurable settings and/or modifications can change the opacity and/or crispness of each of the plurality of planes 301. For instance, the opacity of the plurality of planes 301 can be increased and/or decreased to enhance visual effects.

FIGS. 3A-3C illustrate modifications of the visual effects of the MVMD graph, wherein the visual effects of the plurality of planes 301 are changed simultaneously. Examples are not so limited, however, and the visual effects of a single plane can be changed independent of the rest of the MVMD graph. For instance, the opacity of the first plane 301-1 can be changed, while the opacity of the second plane 301-2, the third plane 301-3, and the fourth plane 301-4 remain unchanged. Similarly, individual polylines (not shown in FIGS. 3A-3C) can be displayed with low or high opacity, and the build-up in opacity due to multiple lines overlapping can reveal denser structures within the MVMD graph.

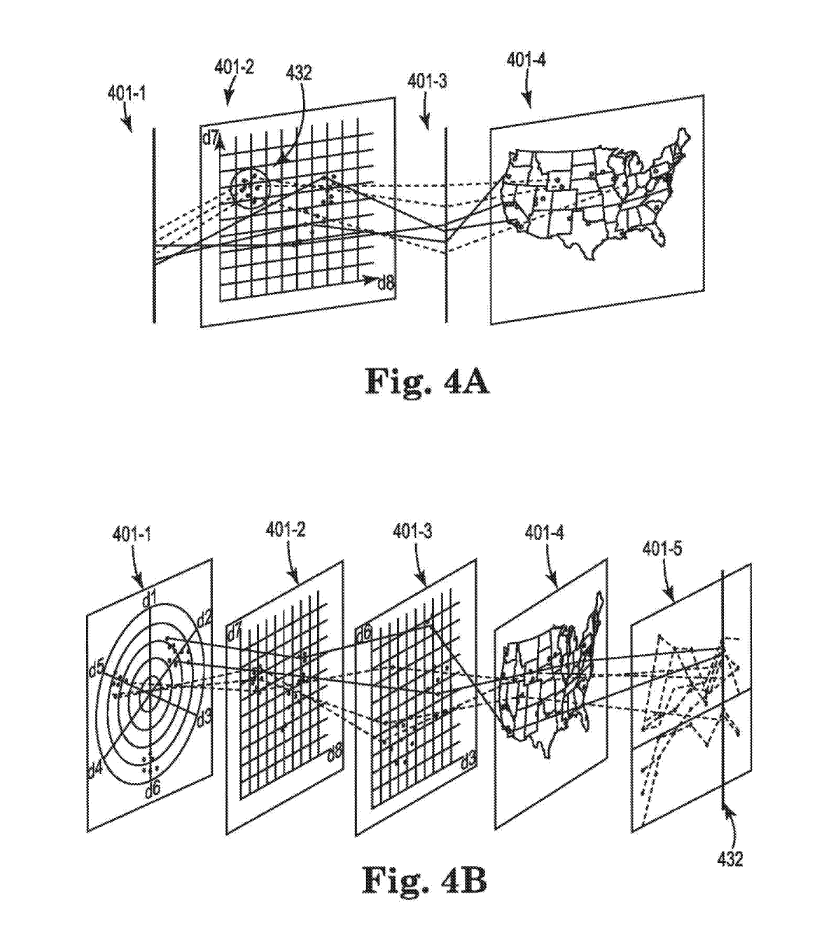

FIGS. 4A-4B illustrate examples of modifications of an MVMD graph according to the present disclosure. In a number of examples, data within the MVMD graph can be explored by visually manipulating components of the MVMD graph. In some examples, large numbers of planes can be displayed at the same time, and screen space may not be available to display all of the planes with sufficient detail. Portions of the MVMD graph can be collapsed, and/or various portions of the data in the MVMD graph can be selected and compared against the remaining planes. For instance, as illustrated in FIG. 4A, a number of planes can be collapsed about an axis, such as the first plane 401-1 and the third plane 401-3. When collapsed, planes can present a simple edge-on view of their data points, and/or the linear representation can be processed to optimally distinguish clusters present in the 2D view.

As illustrated in FIG. 4A, a particular cluster of data can be selected and can be compared across the plurality of planes. By selecting a particular cluster 432 for analysis, data in the plurality of planes 401 can be identified as correlating to the particular cluster 432, and the polylines connecting the correlating data in the plurality of planes 401 can be emphasized. For instance, the polylines associated with cluster 432 (e.g., selected polylines) can be visually depicted in a different color, opacity, line weight, and/or line pattern compared to polylines in the MVMD graph that are not associated with cluster 432 (e.g., unselected polylines). In denser MVMD graphs, the unselected polylines can be rendered with a lower opacity than the selected polylines so as not to interfere with visualizing the selected structure. Similarly, selected polyline segments can be treated as edges to construct and render a bounding volume between each plane.

FIG. 4B further illustrates examples of modifications of an MVMD graph, according to the present disclosure. In a number of examples, a timeline graph (e.g., fifth plane 401-5) can be included in the MVMD graph, and can be utilized to implement a time-varying analysis on the MVMD graph. For example, a user can select a particular point in time (e.g., time point 432) on plane 401-5, and identify data in the plurality of planes 401 that are associated with the time point 432. Data associated with time point 432 can be highlighted and/or otherwise emphasized for visual acuity. In a number of examples, the time point 432 can be dynamically modified (e.g., moved within fifth plane 401-5), and the changes in the polylines correlating to the modified time point (not shown in FIG. 4B) can be illustrated.

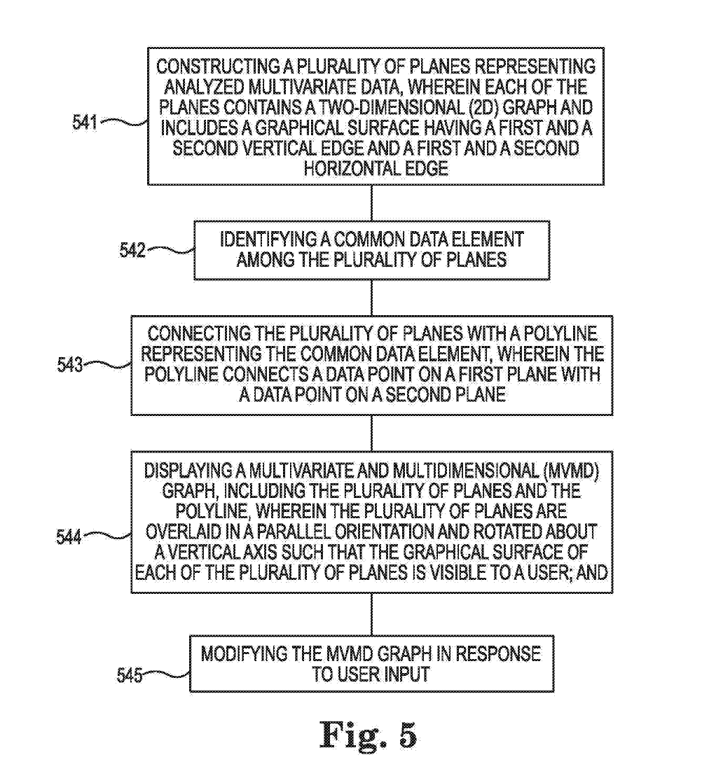

FIG. 5 illustrates a flow chart of an example method 540 for displaying multivariate data in multiple dimensions according to the present disclosure. At 541, the method 540 can include analyzing multivariate data and constructing a plurality of planes representing the analyzed multivariate data, wherein each of the planes includes a graphical surface having a first and a second vertical edge, and a first and a second horizontal edge. In a number of examples, analyzing can include identifying a cluster of data for representation in a graph on a first plane among the plurality of planes.

A number of different types of graphical visualizations can be selected for the 2D graphs. A type of graphical visualization for a particular 2D graph can be selected by a user and/or chosen by a computing system based on the type of data to be presented and/or the type of analysis generating the data. In some examples, each 2D graph can be of a different type, selected from the group including: a RadViz plot, a scatterplot, a geographical data visualization, and a timeline graph.

At 542, the method 540 can include identifying a common data element among the plurality of planes. At 543, the method 540 can include connecting the plurality of planes with a polyline representing the common data element, wherein the polyline connects a data point on a first plane with a data point on a second plane. As discussed further herein, and as illustrated in FIGS. 1A-4B, a plurality of polylines can be illustrated on a plurality of planes.

At 544, the method 540 can include displaying an MVMD graph, including the plurality of planes and the polyline, wherein the plurality of planes are overlaid in a parallel orientation and rotated about a vertical axis such that the graphical surface of each of the plurality of planes is visible to a user. In some examples, a select plane can be added and/or removed from the MVMD graph. Similarly, various planes from within the MVMD graph can be cut, copied and/or pasted from within the MVMD graph to alter the overall visual presentation of the MVMD graph.

In some examples, the order of layering of planes in an MVMD graph can be defined by a user. The order of layering can also be defined by a computing system based on common data elements identified between planes, and/or detected by previous analytics steps. In some instances, a particular plane can be repeated and/or displayed more than one time within the MVMD graph.

At 545 the method 540 can include modifying the MVMD graph in response to user input. In some examples, modifying the MVMD graph can include selecting a cluster or other segment of data for comparison against the plurality of planes. In other examples, modifying the MVMD graph can include time-varying the MVMD graph, wherein time-varying includes linking a data point on a first plane in the MVMD graph with a particular time and identifying data points on the remaining planes corresponding with the particular time. As discussed in relation to FIG. 4B, time-varying can be dynamic.

In some examples, an overall viewpoint of the MVMD graph can be changed. For example, a constructed MVMD graph can be rotated at a 45 degree angle relative to a viewer such that all planes (e.g., layers) are visible. In response to user input to modify the angle of rotation, the MVMD graph can be rotated to a different angle, such as 30 degrees relative to a viewer. Similarly, in response to user input, a select portion and/or the entire MVMD graph can be zoomed into such that the select portion and/or the entire MVMD graph appears larger to a viewer. In some examples, a number of the planes can be oriented in a flat visualization (e.g., traditional 2D visualization) to provide a more conventional face-on view. Additionally, a number of controls can be provided that allow a user to add, save, delete, cut, copy, and/or past a number of planes within the MVMD graph and/or the entire MVMD graph.

The specification examples provide a description of the applications and use of the system and method of the present disclosure. Since many examples can be made without departing from the spirit and scope of the system and method of the present disclosure, this specification sets forth some of the many possible example configurations and implementation.

What is claimed:

1. A non-transitory computer readable medium storing instructions executable by a processing resource to cause a computer to:
select a first graph of a first graph type and a second graph of a second graph type, wherein the first graph includes a first set of data and the second graph includes a second set of data;
identify a data point from the first set of data and a data point from the second set of data that share a common data element;
connect the data point from the first set of data to the data point from the second set of data with a polyline representing the common data element between the two data points; and
display a multivariate and multidimensional (MVMD) graph, wherein the MVMD graph includes the first graph, the second graph, and the polyline.

2. The non-transitory computer-readable medium of claim 1, wherein the first graph is on a first plane having a first and a second vertical edge and a first and a second horizontal edge and the second graph is on a second plane having a first and a second vertical edge and a first and a second horizontal edge.

3. The non-transitory computer-readable medium of claim 2, wherein the instructions executable by the processing resource to display the MVMD graph includes instructions to:
display the first plane and the second plane in a parallel orientation such that the first vertical edge of the second plane overlays the first vertical edge of the first plane; and
rotate the first plane and the second plane about a vertical axis of the MVMD graph such that the first vertical edge of the second plane and the first vertical edge of the first plane are closer to a viewer than the second vertical edge of the second plane and the second vertical edge of the first plane.

4. The non-transitory computer-readable medium of claim 1, wherein the first graph and the second graph are of different graph types selected from the group of point based visualizations including: a RadViz plot, a scatterplot, and a geographical data visualization.

5. A system for displaying and interacting with multivariate data in multiple dimensions, comprising:
a processing resource; and
a memory resource communicatively coupled to the processing resource containing instructions executable by the processing resource to implement:
a data compilation engine to compile data to create a plurality of planes containing two-dimensional (2D) graphs, wherein each of the plurality of planes includes a graphical surface having a first and a second vertical edge, and a first and a second horizontal edge;
a common data element engine to identify a common data element among the plurality of planes selected for a multivariate and multidimensional (MVMD) graph;
a visualization engine to display the MVMD graph, including the plurality of planes, in an orientation wherein the plurality of planes are parallel to one another and rotated about a vertical axis such that the first vertical edge of each of the plurality of planes is closer to a viewer than the second vertical edge of each of the plurality of planes;
a data mapping engine to display a first polyline on the MVMD graph, wherein a polyline connects data points on each of the plurality of planes and represents the common data element among the plurality of planes; and
an interaction engine to display a modification of the MVMD graph in response to a user input.

6. The system of claim 5, wherein the interaction engine collapses selected planes in the MVMD graph down to a single axis.

7. The system of claim 5, wherein the interaction engine modifies a visualization effect of a plane in the MVMD graph, in response to the user input.

8. The system of claim 7, wherein:
the visualization effect includes changing spatial orientation of a first plane and a second plane such that:
the first plane and the second plane display perspective cues;
the first plane and the second plane are of a substantially similar size; and
the first plane and the second plane are of a substantially similar aspect ratio.

9. The system of claim 5, wherein the interaction engine:
displays a high density area of data points on a plane among the plurality of planes; and
displays a second polyline associated with the high density area.

10. A method for displaying multivariate data in multiple dimensions, comprising:
constructing a plurality of planes representing analyzed multivariate data, wherein each of the planes contains a two-dimensional (2D) graph and includes a graphical surface having a first and a second vertical edge and a first and a second horizontal edge;
identifying a common data element among the plurality of planes;
connecting the plurality of planes with a polyline representing the common data element, wherein the polyline connects a data point on a first plane with a data point on a second plane;
displaying a multivariate and multidimensional (MVMD) graph, including the plurality of planes and the polyline, wherein the plurality of planes are overlaid in a parallel orientation and rotated about a vertical axis such that the graphical surface of each of the plurality of planes is visible to a user; and
modifying the MVMD graph in response to user input.

11. The method of claim 10, wherein constructing a plurality of planes representing analyzed multivariate data includes identifying a cluster of data for representation in the first plane.

12. The method of claim 11, wherein modifying the MVMD graph includes selecting the cluster of data for comparison against the plurality of planes.

13. The method of claim 10, wherein modifying the MVMD graph includes time-varying the MVMD graph, wherein time-varying includes:
linking data on the first plane with a particular time point and identifying data on the second plane corresponding with the particular time point.

14. The method of claim 13, wherein linking data on the first plane with a particular time point includes selecting a period of time on a timeline graph.

15. The method of claim 10, wherein modifying the MVMD graph includes at least one of adding and removing particular planes from the MVMD graph.
